(19) United States
(12) Patent Application Publication
(10) Pub. No.: US 2002/0110732 A1
(43) Pub. Date: Aug. 15, 2002

(54) Battery cell fabrication process

(75) Inventors: Fabrice Coustier, Dublin, CA (US); Richard Bradford, Livermore, CA (US)

Correspondence Address: BEYER WEAVER & THOMAS LLP, P.O. BOX 778, BERKELEY, CA, 94704-0778, US

(73) Assignee: PolyStor Corporation

(21) Appl. No.: 09/745,910

(22) Filed: Dec. 20, 2000

(51) Int. Cl. H01M 2/16; H01M 2/18; B05D 5/12; H01M 2/02

(52) U.S. Cl. 429/144; 429/176; 29/623.5; 427/58

(57) ABSTRACT

Provided are alternative fabrication methods and compositions for an electrochemical cell. The methods of the present invention are applicable to the manufacture of polymer-cased lithium-ion secondary battery cells. They are particularly, but not exclusively, applicable to manufacturing scale processes of fabricating polymer-cased lithium-ion secondary battery cells. Briefly, the present invention provides an electrochemical cell fabrication process wherein a binder is applied to a porous battery separator material. Binder solutions in accordance with the present invention, are formulated with a low boiling/high solubility (“good”) solvent and a higher boiling/no or low solubility (“bad”) solvent to dissolve the binder and coat it on the separator. When the separator is subsequently dried by evaporation of the solvents, a porous coating of binder is formed on the separator material.

### BACKGROUND OF THE INVENTION

The present invention relates to electrochemical energy storage devices (electrochemical cells). More particularly, the invention relates to a method of fabricating a polymer-cased battery cell having a porous separator.

Due to the increasing demand for battery-powered electronic equipment, there has been a corresponding increase in demand for rechargeable electrochemical cells having high specific energies. In order to meet this demand, various types of rechargeable cells have been developed, including improved aqueous nickel-cadmium batteries, various formulations of aqueous nickel-metal hydride batteries, nonaqueous rechargeable lithium-metal cells and nonaqueous rechargeable lithium-ion cells. While rechargeable lithium-metal cells have high energy densities and specific energies, they have historically suffered from poor cycle life, discharge rate, and safety characteristics, and so have not gained widespread acceptance.

Lithium-ion cells (sometimes referred to as “lithium rocking chair,” or “lithium intercalation” cells) are attractive because they preserve much of the high cell-voltage and high specific-energy characteristics of lithium-metal cells. Because of their superior performance characteristics in a number of areas, they quickly gained acceptance in portable electronics applications following their introduction in the early 1990's. Lithium-ion cells retain their charge considerably longer than comparable nickel-cadmium (NiCad) cells and are significantly smaller, both of which are desirable characteristics since manufacturers seek to make electronic products smaller and portable.

Battery cells are primarily composed of a positive electrode, a negative electrode, and an ion-conducting separator interposed between the two electrodes. Conventional lithium-ion battery cells have typically used as a separator a porous polymer film, such as polyethylene, polypropylene, polytetrafuoroethylene, polystryrene, polyethyleneterphtalate, ethylenepropylene diene monomer (EPDM), nylon and combinations thereof, filled with an electrolyte solution. Also, conventional cells are enclosed in a rigid case, typically made of stainless steel, in order to apply pressure to the cell components to maintain good electrical connections between the components.

In order to reduce the size and weight of battery cells, more recently attempts have been made to develop lithium-ion battery cells which do not require the rigid case in order to maintain good electrical connections between the battery cell's components. Instead of rigid cell casings, these cells may be packaged in polymer pouches. Various adhesives and binders have been proposed in order to provide sufficient adhesive strength between the components of such polymer-cased cells. Such binders include, for example, polyurethane, polyethylene oxide, polyacrylonitrile, polymethylacrylate, polyacrylamide, polyvinylacetate, polyvinylpyrrolidone, polytetrafluoroethylene, glycol diacrylate, polyvinylidene fluoride (PVDF), hexafluoro propylene (HFP), chlorotetrafluoro ethylene (CTFE) and copolymers of the foregoing and combinations thereof.

It is well known that a porous separator enhances the performance of a lithium-ion battery cell by facilitating electrolyte and ion flow between the electrodes. Typical separators used in lithium-ion battery cells are porous polymers, such as polyethylene, polypropylene or mixtures thereof. Previously described methods for fabricating polymer-cased lithium-ion battery cells have involved applying a binder resin solution, such as PVDF, to a porous separator, for example composed of polyethylene, and then adhering and laminating the positive and negative electrodes to the binder-coated separator. Thereafter, the binder resin solvent was evaporated to form the battery cell electrode laminate. Subsequently, the laminate was impregnated with electrolyte solution in a pouch, which was then sealed to complete the cell.

One drawback of the application of binder to a porous polymer separator is that the binder may form a solid, continuous film over all or part of the surface of the separator to which it is applied thereby substantially reducing the porosity of the separator. Reduced porosity results in degraded performance ion transport through the separator is slowed increasing cell impedance and reducing the cell's high rate capability. Further, while the process of making gel-polymer batteries in lab scale (e.g., few batteries per day) or even pilot line (e.g., few hundreds per day) does not require a very fast wetting of the jellyroll or stack, at manufacturing quantities (e.g., thousands per day) the separator needs to absorb the electrolyte very fast (e.g., within a few seconds). Reduced separator porosity may render such a manufacturing process unfeasible, or at least sub-optimal.

Thus, an improved process of fabricating a battery cell having a porous binder-coated separator would be desirable.

### SUMMARY OF THE INVENTION

To achieve the foregoing, the present invention provides alternative fabrication methods and compositions for an electrochemical cell. The methods of the present invention are applicable to the manufacture of polymer-cased lithium-ion secondary battery cells. They are particularly, but not exclusively, applicable to manufacturing scale processes of fabricating polymer-cased lithium-ion secondary battery cells. Briefly, the present invention provides an electrochemical cell fabrication process wherein a binder is applied to a porous battery separator material. Binder solutions in accordance with the present invention, are formulated with a low boiling/high solubility (“good”) solvent and a higher boiling/no or low solubility (“bad”) solvent to dissolve the binder and coat it on the separator. When the separator is subsequently dried by evaporation of the solvents, a porous coating of binder is formed on the separator material.

The process and compositions of the present invention have the advantage that they may be used to produce a porous binder on a porous separator material. Such a porous separator avoids the degraded performance caused by reduced porosity and facilitates the manufacturing scale automation of the process of making gel-polymer batteries. Some binder-coated separators in accordance with the present invention are suitable for incorporation in polymer-cased electrochemical cells wherein the binder (e.g., PVDF) provides rigidity to the cell.

In one aspect, the invention provides a method of making an electrochemical cell electrode separator. The method involves contacting a porous separator material with a solution of a binder material, where the binder solution comprising at least two solvents, the first of the at least two solvents having a higher solubility for the binder material and a lower boiling point than the second of the at least two solvents, and the solution of binder material not gelling at a temperature below 30° C. for a minimum of 4 hours. The solvents are evaporated such that a porous coating of binder is formed on the separator material forming a coated separator. This method may also be applied to the fabrication of an electrochemical cell.

In another aspect, the invention provides an electrochemical cell separator. The separator include a porous separator material and a porous coating of a binder formed on the separator material. The coated separator has a porosity such that the time for a known volume of air to pass through an area of coated separator is no more than three times the time for the known volume of air to pass through the same area of the uncoated porous separator material under the same conditions.

In another aspect, the invention provides an electrochemical cell. The cell includes an electrochemical structure having a positive electrode, a negative electrode, and a porous binder-coated separator separating the two electrodes. The coated separator has a porosity such that the time for a known volume of air to pass through an area of coated separator is no more than three times the time for the known volume of air to pass through the same area of the uncoated porous separator material under the same conditions. The cell also includes an electrolyte and a polymer casing for the electrochemical structure and electrolyte.

In yet another aspect, the invention provides an electrochemical cell binder solution. The solution includes a binder material and at least two solvents. The first of the at least two solvents has higher solubility for the binder material and a lower boiling point than the second of the at least two solvents, and the solution of binder material does not gel at a temperature below 30° C. in less than 4 hours.

These and other features and advantages of the present invention are described below with reference to the drawings.

### BRIEF DESCRIPTION OF THE DRAWINGS

FIG. 1 depicts a portion of a single laminate layer of an electrochemical structure having a separator in accordance with one embodiment of the present invention.

FIGS. 2A and 2B illustrate basic jellyroll and stacked electrochemical structures for cells in accordance with the present invention.

FIG. 3 depicts a completed battery cell in accordance with the present invention.

FIG. 4 depicts a flow chart presenting aspects the fabrication of an electrochemical cell in accordance with one embodiment of the present invention.

### DETAILED DESCRIPTION OF PREFERRED EMBODIMENTS

Reference will now be made in detail to preferred embodiments of the invention. Examples of the preferred embodiments are illustrated in the accompanying drawings. While the invention will be described in conjunction with these preferred embodiments, it will be understood that it is not intended to limit the invention to such preferred embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

The present invention provides alternative fabrication methods and compositions for an electrochemical cell. The methods of the present invention are applicable to the manufacture of polymer-cased lithium-ion secondary battery cells. They are particularly, but not exclusively, applicable to manufacturing scale processes of fabricating polymer-cased lithium-ion secondary battery cells. Briefly, the present invention provides an electrochemical cell fabrication process wherein a binder is applied to a porous battery separator material. Binder solutions in accordance with the present invention, are formulated with a low boiling/high solubility (“good”) solvent and a higher boiling/no or low solubility (“bad”) solvent to dissolve the binder and coat it on the separator. While not wishing to be bound by theory, it is believed that when the separator is subsequently dried by evaporation of the solvent, the lower boiling “good” solvent is removed first causing the binder to precipitate from solution into suspension in the “bad” solvent. Thus, the coating of binder solution on the separator is composed of connected pockets of the bad solvent. The bad solvent is removed upon further drying leaving a porous coating of binder on the separator. Preferred binder-solvent solutions in accordance with the present invention are stable and do not gel at temperatures below 30° C. for at least about 2 to 12 hours. In preferred implementations, binder-solvent solutions in accordance with the present invention do not gel at temperatures below 30° C. for at least 4 hours, more preferably at least 8 hours, most preferably at least 12 hours or more.

The process and compositions of the present invention have the advantage that they may be used to produce a porous binder on a porous separator material. Such a porous separator avoids the degraded performance caused by reduced porosity and facilitates the manufacturing scale automation of the process of making gel-polymer batteries. Some binder-coated separators in accordance with the present invention are suitable for incorporation in polymer-cased electrochemical cells wherein the binder (e.g., PVDF) provides rigidity to the cell.

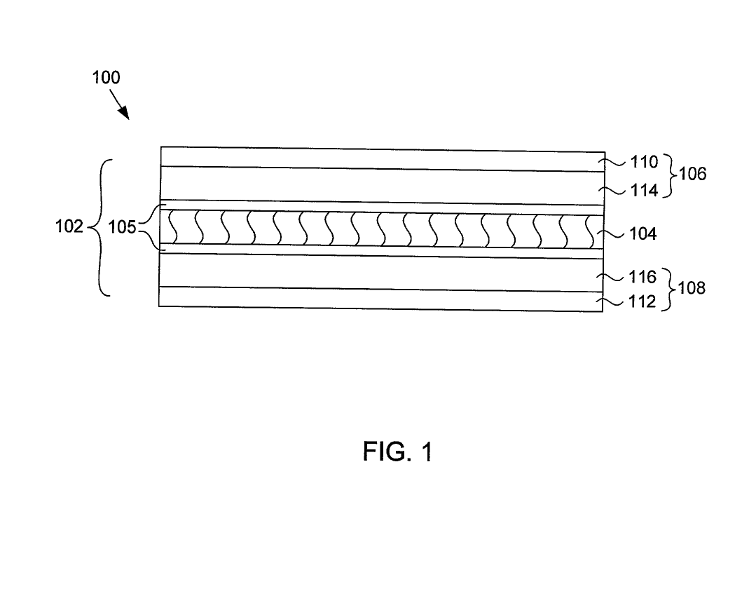

Referring to FIG. 1, a portion 100 of a single laminate layer 102 of an electrochemical structure having a separator in accordance with one embodiment of the present invention is illustrated. As further described below, the electrochemical structure is typically in the form of jellyroll (wound laminate) or stack. The layer 102 includes a porous separator 104 interposed between a positive electrode 106 and a negative electrode 108. The separator is coated with a binder 105 to enhance the bonding of the structure's components to each other. The electrodes 106, 108 are typically formed on current collectors 110, 112, respectively, which may be composed of a highly conductive metal, such as copper or aluminum. For example, the positive electrode 106 may be composed of a cathode material 114 on an aluminum foil current collector 110, and the negative electrode 108 may be composed of an anode material 116 on a copper foil current collector 112.

In one embodiment of this aspect of the present invention, the components of the electrochemical structure may be composed of appropriate materials known to those of skill in the art. Suitable materials for a lithium-ion cell include, for example, for the positive electrode, carbon (as an electronic conductor), active material (e.g., lithium cobalt oxide, lithium manganese oxide, or lithium nickel oxide), and a binder (such as PVDF), and for the negative electrode, carbon as an active material with a binder (such as PVDF). As noted above, the electrodes are typically formed on current collectors, which may be composed of a highly conductive metal, such as copper or aluminum. The separator may be composed of a porous polyolefin, preferably polyethylene, polypropylene, or a combination of the two, coated as described below. Other possible separator materials include polytetrafuoroethylene, polystryrene, polyethyleneterphtalate, ethylenepropylene diene monomer (EPDM), nylon and combinations thereof. The separator is typically filled with a liquid electrolyte composed of a solvent and a lithium salt. Sample liquid electrolyte compositions for lithium ion cells in accordance with the present invention may include solvents such as propylene carbonate, ethylene carbonate, diethyl carbonate, dimethyl carbonate, ethyl methyl carbonate, dipropyl carbonate, dimethyl sulfoxide, acetonitrile and combinations thereof, a lithium salt having Li³⁰ as the cation and one of PF₆⁻, AsF₆⁻, BF₄⁻, ClO₄⁻, CF₃SO₃⁻, N(CF₃SO₂)₂⁻ as the anion.

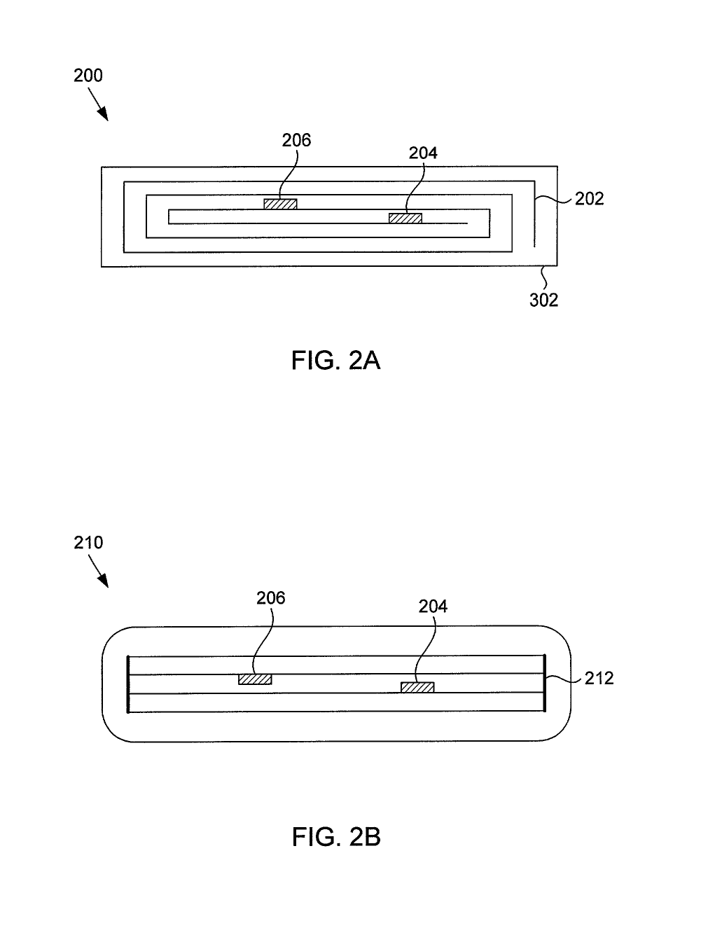

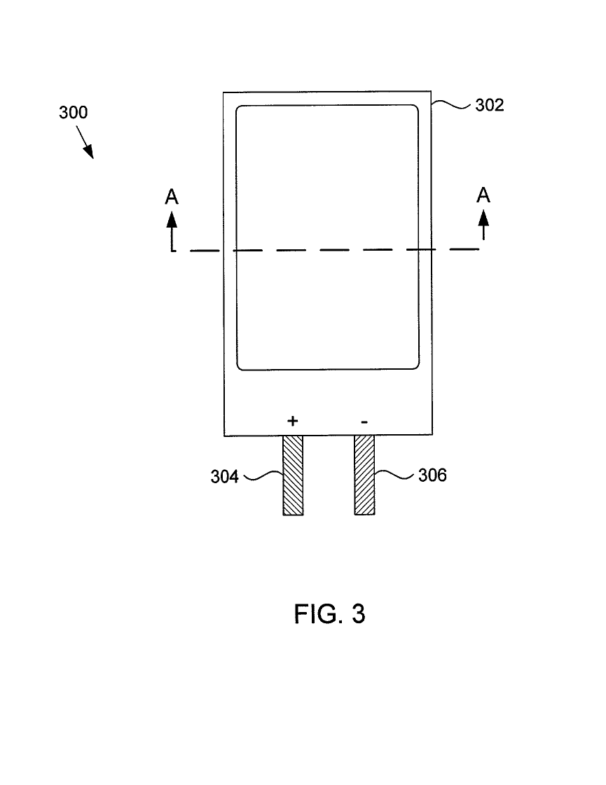

As noted above, an electrochemical structure for a cell in accordance with the present invention is typically in the form of a “jellyroll” (wound laminate) or stack. FIGS. 2A and 2B illustrate basic jellyroll and stacked electrochemical structures for cells in accordance with the present invention. FIG. 2A depicts an enlarged cross-sectional view of a cell (along the line A-A, FIG. 3) depicting a jellyroll structure 200 in accordance with one embodiment of the present invention. The jellyroll design 200 is formed by winding a laminate layer 202. FIG. 2B depicts an enlarged cross-sectional view of a cell (along the line A-A, FIG. 3) depicting a stacked structure 210 in accordance with one embodiment of the present invention. The stack 210 may be formed by stacking a series of laminate layers 212. In each case, a positive lead 204 is attached, e.g., by welding, to a portion of the positive electrode's current collector and a negative lead 206 is attached to a portion of the negative electrode's current collector. Winding, stacking, and associated fabrication techniques for cells described herein are well known to those skill in the art.

Referring to FIG. 3, in a completed battery cell in accordance with the present invention 300, an electrochemical structure having a porous binder-coated separator is packaged in a cell container 302. In one embodiment of the present invention, the cell container may be composed of a substantially gas-impermeable barrier material composed a polymer-laminated metal material that is lightweight and flexible. Such cell container materials are well known in the art for use in packaging gel-polymer as well as solid state polymer cell batteries. A particularly preferred cell container material is polymer-laminated aluminum foil, such as product number 96031, available from Pharma Center Shelbyville, Inc, of Shelbyville, Ky. Leads 304, 306 connected to each of the positive and negative electrodes of the cell as described above, extend from the sealed cell container 302 for external electrical connection.

Lamination of the electrodes and separator may be conducted according to any suitable method such as are known in the art, and may take place either before or after the cell is sealed in its container. Lamination and sealing techniques for cells such as those described herein are well known to those skill in the art. Lamination may use, for example, a first press at about 100 psi and 110° C. for about 2 minutes, followed by a second 100 psi press for about 2 minutes at room temperature in packaging with electrolyte.

The present invention is primarily directed to a process and compositions for applying a binder material to an electrochemical separator material to form a porous, binder-coated separator. In some embodiments, such a porous, binder-coated separator, for instance, where the binder used includes PVDF, provides the final battery cell with some rigidity after lamination/curing. In accordance with the present invention a porous separator material may be dip-coated, spray-coated, painted or otherwise coated with a binder solution. The binder solution may include polyurethane, polyethylene oxide, polyacrylonitrile, polymethylacrylate, polyacrylamide, polyvinylacetate, polyvinylpyrrolidone, polytetrafluoroethylene, glycol diacrylate, polyvinylidene fluoride (PVDF), and copolymers of the foregoing and combinations thereof. In one preferred embodiment, the binder solution may be a PVDF homopolymer. It may also include a PVDF co-polymer, for example with hexafluoropropylene (HFP) (e.g., about 0-8%, for example 5%) or chlorotrifluoroethylene (CTFE), for example.

A binder for use in accordance with the present invention is preferably selected for characteristics consistent with optimal cell integrity and performance. It has been found that the physical integrity for a battery cell as well as the battery's performance and safety may be enhanced by selecting a binder material having certain chemical-physical characteristics. For example, in some embodiments of the present invention, PVDF may be used as a binder material. Where PVDF is used, it preferably has a high crystallinity (e.g., greater than 50%), a high molecular weight (e.g., greater than 300,000), and a high melting point (e.g., greater than 160° C.). Examples of such preferred PVDFs include Kynar 301F and Kynar 741, available from Elf Atochem, King of Prussia, PA, and Solef 6020, available from SOLVAY, Brussels, Belgium.

In general, the binder is dissolved in a solvent system of at least two solvents; from about 1 to 15% binder in solvent, preferably about 1 to 4% binder in solvent, most preferably about 2% binder in solvent. In accordance with the present invention, binder solutions are formulated with a low boiling/high solubility (“good”) solvent and a higher boiling/no or low solubility (“bad”) solvent to dissolve the binder and coat it on the separator. It is believed that, when the separator is subsequently dried by evaporation, the lower boiling solvent is removed first. The binder precipitates from solution. Thus, the coating of binder solution on the separator is composed of connected pockets of the bad solvent. The bad solvent is removed upon further drying leaving a porous coating of binder on the separator.

In accordance with the present invention, combinations of “good” and “bad” solvents may also include intermediate (i.e., moderate solubility for the binder material) or latent i.e., poor solubility for the binder material). Such solvents may provide other desirable characteristics, such as enhanced shelf life for the binder solution, etc. Alternatively, mixtures of three or more solvents, including more than one “good” solvent, can be used along with mixtures of one or more bad solvent to achieve such desirable characteristics.

For example, for a PVDF-based binder solution in accordance with one embodiment of the present invention, “good” solvents may include: acetone, tetrahydrofuran, methyl ethyl ketone, dimethyl formamide, dimethyl acetamide, tetramethyl urea, dimethyl sulfoxide, trimethyl phosphate, N-methyl pyrrolidone (NMP). “Bad” solvents include: pentane, methyl alcohol, hexane, carbon tetrachloride, benzene, trichloroethylene, isopropyl acetate, ethyl alcohol, toluene, tetrachloroethylene, xylene, o-chlorobenzene, decane; generally, aliphatic hydrocarbons, aromatic hydrocarbons, chlorinated solvents, and alcohols. In addition to “good” and “bad” solvents, other solvents may be characterized in the field as “intermediate or “latent” solvents. “Intermediate” solvents include: butyrolactone, isophorone, and carbitol acetate. “Latent” solvents include: methyl isobutyl ketone, n-butyl acetate, cyclohexanone, diacetone alcohol, diisobutyl ketone, ethyl aceto acetate, triethyl phosphate, propylene carbonate, ethylene carbonate, dimethyl carbonate, diethyl carbonate, dimethyl phtalate, glycol ethers, glycol ether esters; carbonates generally. For the purposes of the present application, intermediate and latent solvents may act as “good” or “bad” solvents, respectively, depending on the particular combination of solvents used, or they may supplement a good/bad solvent combination. The same principles are applicable to binder materials other than PVDF, and given the disclosure herein one of skill in the art will be bale to determine suitable solvent combinations with minimum experimentation.

Prior to application to a separator material, the binder is dissolved in a combination of solvents including at least one “good” solvent and at least one “bad” solvent, as noted above, to form a binder solution. In one embodiment, the solution may be prepared as follows: The PVDF powder along with the suitable combination of solvents is mixed under heat. A mixer, such as are available from Charles Ross and Son Company, Hauppage, N.Y. (Model No. PG40) may be used. After the boiling point of the solution is reached and/or when the solution becomes transparent rather than white-opaque, the solution is cooled down to room temperature and is ready for coating.

In a preferred embodiment, the ratio of solvents can be from about 99% good/1% bad (including intermediate and/or latent) to about 50% good/50% bad, preferably about 80% good/20% bad. In general, the solvents of the solvent system should be selected so that they produce a stable solution of the binder material. Given the guidance, including the specific examples, provided in this application, one of skill in the art would be able to select and combine appropriate solvents with minimal experimentation.

Some preferred solvents and their ratios of use in the binder solution include 90% acetone-10% ethanol; 90% acetone-10% methanol; 80% acetone-20% ethanol; and 80% acetone-20% methanol. For manufacturing reasons, an extended shelf life (e.g., at least about 8 to 12 hours, and preferably at least two to five days) is also recommended. In some instances, the shelf life of the binder solution may be extended by the addition of a third solvent, for example, NMP. Some examples of appropriate long shelf life three-solvent combinations are 89% acetone-1%NMP-10% ethanol and 88% acetone-2%NMP-10% ethanol.

For example, a microporous polyethylene separator film may be coated with a solution of about 2% PVDF dissolved in a mixture of about 90% acetone and 10% ethanol. Acetone is a good solvent for PVDF and has a boiling point of about 56° C. Ethanol is a bad solvent for PVDF and has a boiling point of about 79° C. When the binder-coated separator film is dried the resulting separator is porous polyethylene coated with a porous PVDF binder layer. Such a binder solution may be stored before use and is well-suited for manufacturing purposes (where the binder solution would remain liquid at room temperature for substantial periods of time, e.g., at least about 8 to 12 hours, in order to be used in a commercially viable manufacturing process) as it is a stable solution of binder in good and bad solvents that will not gel quickly, but instead will form a porous coating on the porous separator material when applied and the solvents evaporated. This is important to note given that other combinations of good and bad solvents (e.g., methyl ethyl ketone (MEK)-2-butanol; acetone-formamide) would gel in minutes if not kept warm (e.g., above 30° C.), and as such would not be suitable for storage and manufacturing purposes. As noted above, the shelve life of a binder solution in accordance with the present invention may be further extended by the addition of one or more additional solvents.

Manufacturing scale production of electrochemical separator in accordance with the present invention may be conducted using standard or custom industry equipment and methods adapted to the purpose. The binder may be applied to one side of the separator material at a time or, in another embodiment, both sides simultaneously.

For example, a roll of the separator material on a backing material, such as paper, plastic, or metal foil, may be coated on one side at a time with a binder solution in accordance with the present invention. The coated separator material is then dried by evaporation of the binder solution solvents to form a porous binder coating on one side of the separator material. After coating the first side, the roll is reversed and the same process is used again to coat the second side of the separator with binder solution. Suitable coating equipment is available from Hirano Tecseed Co. Ltd., Nara, Japan. In one embodiment, the equipment may be operated at about 10 meters per minute with a gap of about 60 to 70 microns and an oven temperature of about 30-60° C. (e.g., a temperature progression from about 30° C. to 50° C. to 60° C. in the three oven zones of this particular apparatus).

Alternatively, a roll of the separator material may be coated on both sides simultaneously, by running the separator material through a dipping bath of a binder solution in accordance with the present invention. The separator is impregnated with binder solution using this dip-coating method. The coated separator material is then dried by evaporation of the binder solution solvents to form a porous binder coating on both sides of the separator material. Suitable dip-coating equipment is available. In one embodiment, the equipment may be operated at about 10 meters per minute with an oven temperature of about 65° C.

The binder-coated separator may be carried through an air permeometer apparatus (e.g., Genuine Gurley™ 4320 (Automatic Digital Timer), available from Gurley Precision Instruments, Troy, N.Y., in order to determine if the coating had been successfully made porous. The output of a Gurley apparatus, referred to as a “Gurley number,” is the number of seconds required for a known volume of air to go through a known area (e.g., 1 inch²) of a membrane. In preferred embodiments of the present invention, the Gurley number for the binder-coated separator does not exceed three times the Gurley number of the uncoated separator material, in some cases about two times, and in some other cases no more than about 1.5 times the Gurley number of the uncoated separator material.

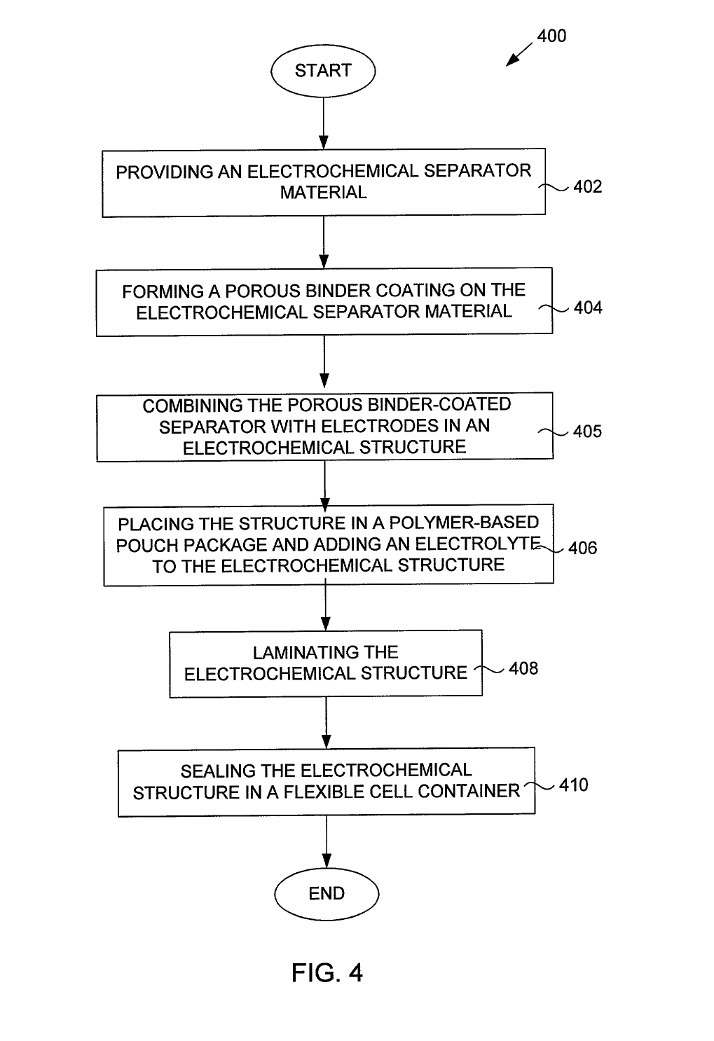

Electrochemical cells in accordance with the present invention may be fabricated using the porous binder-coated separators so formed together with other electrochemical cell components and manufacturing techniques such as are well-known in the art. FIG. 4 illustrates a process flow 400 for coating a porous cell separator and fabricating a battery cell in accordance with one embodiment of the present invention. Processes in accordance with the present invention may include up to several additional steps not described or illustrated here in order not to obscure the present invention. In addition, some steps of the process may be omitted according to some embodiments of the present invention. Also, the order of the steps is not limited to that presented in FIG. 4; certain steps may be reversed in order or combined, for example as described elsewhere herein.

The process flow 400 begins by providing an electrochemical cell separator material, such as porous polyethylene (402). The cell separator material is coated with a binder as described herein to form a porous binder-coated separator (404). The porous binder-coated separator is combined with electrodes in an electrochemical cell structure such as described, for example, as described above and in applicant's U.S. patent application Ser. No. 09/565,204, the disclosure of which is incorporated by reference herein in its entirety and for all purposes (405). The electrochemical structure incorporating porous binder-coated separator is placed in a polymer-based pouch and an electrolyte is added to the structure (406). The structure is laminated/cured (408) and sealed in a flexible cell container (410).

### EXAMPLES

The following examples provide additional experimental details relating to processes and compositions in accordance with the present invention in order to show the successful fabrication of the porous binder-coated separators. This material intended to assist in an understanding of the present invention and should not be construed to limit the scope of the invention.

In a Ross mixer (Model #PD40), 2% in weight of Kynar 301F PVDF was mixed with 86.24% of Acetone, 9.8% of ethanol and 2% of NMP. The solution was mixed and heated up until the temperature reached about 50° C. and/or the solution became transparent. The solution was then cooled down to room temperature before use.

A microporous polyethylene separator was carried at a rate of about 20 feet per minute (about 7 m/min) through a dipping pan containing the solution using an experimental dip-coating apparatus. The drying oven temperature was 65° C.

In this case, a microporous separator having a Gurley (permeometer) number of 430 seconds for 100 cc of air when uncoated, had a Gurley number of 900 seconds after coating. The separator can then be assembled with electrodes to form a gel polymer lithium-ion battery. This may be contrasted with the coating of a 2% solution of PVDF (e.g., Solef 6020) in a single solvent (e.g., DMF), for which the recorded Gurley number is infinity (i.e., the coated porous separator material has virtually no permeability).

The following table provides the Gurley results for binder coated separators prepared substantially as described above using a variety of solvent combinations in accordance with the present invention:

| | | | | Ratio of |
|---|---|---|---|---|
| PVDF | Solvent 1 | Solvent 2 | Solvent 3 | Gurley numbers |
| 2% in | 90% Acetone | 10% Ethanol | | 1.4 |
| 2% in | 88% Acetone | 10% Ethanol | 2% NMP | 2.1 |
| 2% in | 80% Acetone | 20% Ethanol | | 1.3 |

### CONCLUSION

The process and compositions of the present invention have the advantage that they may be used to produce a porous binder on a porous separator material. Such a porous separator avoids the degraded performance caused by reduced porosity and facilitates the manufacturing scale automation of the process of making gel-polymer batteries. Some binder-coated separators in accordance with the present invention are suitable for incorporation in polymer-cased electrochemical cells wherein the binder (e.g., PVDF) provides rigidity to the cell.

Although the foregoing invention has been described in some detail for purposes of clarity of understanding, it will be apparent that certain changes and modifications may be practiced within the scope of the appended claims. It should be noted that there are many alternative ways of implementing both the process and compositions of the present invention. Accordingly, the present embodiments are to be considered as illustrative and not restrictive, and the invention is not to be limited to the details given herein, but may be modified within the scope and equivalents of the appended claims.

What is claimed is:

1. A method of making an electrochemical cell electrode separator, comprising:
contacting a porous separator material with a solution of a binder material, said binder solution comprising at least two solvents, wherein a first of said at least two solvents has higher solubility for the binder material and a lower boiling point than a second of said at least two solvents, and wherein the solution of binder material does not gel at a temperature below 30° C. for a minimum of 4 hours; and
evaporating said at least two solvents such that a porous coating of binder is formed on the separator material forming a coated separator.

2. The method of claim 1, wherein the solution of binder material does not gel at a temperature below 30° C. for a minimum of 8 hours.

3. The method of claim 1, wherein the solution of binder material does not gel at a temperature below 30° C. for a minimum of 12 hours.

4. The method of claim 1, wherein the solution of binder material does not gel at a temperature below 30° C. for a minimum of 3 days.

5. The method of claim 1, wherein the binder material is selected from the group consisting of polyvinylidene fluoride (PVDF), polyurethane, polyethylene oxide, polyacrylonitrile, polymethylacrylate, polyacrylamide, polyvinylacetate, polyvinylpyrrolidone, polytetrafluoroethylene, glycol diacrylate, hexafluoropropylene (HFP), chlorotetrafluoroethylene (CTFE) and copolymers of the foregoing and combinations thereof.

6. The method of claim 5, wherein the binder material comprises polyvinylidene fluoride (PVDF).

7. The method of claim 5, wherein the binder material consists of polyvinylidene fluoride (PVDF) homopolymer.

8. The method of claim 1, wherein the binder material comprises about 1 to 15% (by weight) of the binder solution.

9. The method of claim 1, wherein the binder material comprises about 1 to 4% (by weight) of the binder solution.

10. The method of claim 1, wherein the binder material comprises about 2% (by weight) of the binder solution.

11. The method of claim 1, wherein the binder solution comprises between about 99% of the first solvent/1% of the second solvent and 50% of the first solvent/50% of the second solvent.

12. The method of claim 11, wherein the binder solution comprises about 99 to 80% of the first solvent and about 1 to 20% of the second solvent.

13. The method of claim 1, wherein said first solvent is selected from the group consisting of acetone, tetrahydrofuran, methyl ethyl ketone, dimethyl formamide, dimethyl acetamide, tetramethyl urea, dimethyl sulfoxide, trimethyl phosphate, N-methyl pyrrolidone, butyrolactone, isophorone, carbitol acetate, and mixtures thereof.

14. The method of claim 13, wherein said first solvent is selected from the group consisting of acetone, tetrahydrofuran, methyl ethyl ketone, dimethyl formamide, dimethyl acetamide, tetramethyl urea, dimethyl sulfoxide, trimethyl phosphate, N-methyl pyrrolidone, and mixtures thereof.

15. The method of claim 1, wherein said second solvent is selected from the group consisting of aliphatic hydrocarbons, aromatic hydrocarbons, chlorinated solvents, alcohols, methyl isobutyl ketone, n-butyl acetate, cyclohexanone, diacetone alcohol, diisobutyl ketone, ethyl aceto acetate, triethyl phosphate, propylene carbonate, ethylene carbonate, dimethyl carbonate, diethyl carbonate, dimethyl phtalate, glycol ethers, glycol ether esters, and mixtures thereof.

16. The method of claim 15, wherein said second solvent is selected from the group consisting of pentane, methyl alcohol, hexane, carbon tetrachloride, benzene, trichloroethylene, isopropyl acetate, ethyl alcohol, toluene, tetrachloroethylene, xylene, o-chlorobenzene, decane, and mixtures thereof.

17. The method of claim 1, further comprising one of one or more solvents having solubility intermediate between the first and second solvents for the binder material.

18. The method of claim 17, wherein said one or more solvents having solubility intermediate between the first and second solvents is selected from the group consisting of butyrolactone, isophorone, carbitol acetate, methyl isobutyl ketone, n-butyl acetate, cyclohexanone, diacetone alcohol, diisobutyl ketone, ethyl aceto acetate, triethyl phosphate, propylene carbonate, ethylene carbonate, dimethyl carbonate, diethyl carbonate, dimethyl phtalate, glycol ethers, glycol ether esters, and mixtures thereof.

19. The method of claim 1, wherein said binder solution comprises about 2% (by weight) PVDF in about 80 to 90% acetone-20 to 10% ethanol.

20. The method of claim 1, wherein said binder solution comprises about 2% (by weight) PVDF in about 90% acetone-10% ethanol.

21. The method of claim 1, wherein said binder solution comprises about 2% (by weight) PVDF in about 88-89% acetone-1-2% NMP-10% ethanol.

22. The method of claim 1, wherein said coated separator has a porosity such that the time for a known volume of air to pass through an area of coated separator is no more than three times the time for the known volume of air to pass through the same area of the uncoated porous separator material under the same conditions.

23. The method of claim 1, wherein said coated separator has a porosity such that the time for a known volume of air to pass through an area of coated separator is about two times the time for the known volume of air to pass through the same area of the uncoated porous separator material under the same conditions.

24. The method of claim 1, wherein said coated separator has a porosity such that the time for a known volume of air to pass through an area of coated separator is no more than one and one half times the time for the known volume of air to pass through the same area of the uncoated porous separator material under the same conditions.

25. A method of making an electrochemical cell, comprising:
contacting a porous separator material with a solution of a binder material, said binder solution comprising at least two solvents, wherein a first of said at least two solvents has higher solubility for the binder material and a lower boiling point than a second of said at least two solvents, and wherein the solution of binder material does not gel at a temperature below 30° C. for a minimum of 12 hours; and
evaporating said at least two solvents such that a porous coating of binder is formed on the separator material; and
forming an electrochemical structure having,
a positive electrode,
a negative electrode, and
the porous binder-coated separator separating the two electrodes;
packaging said electrochemical structure in a polymer casing;
applying electrolyte to said structure in said polymer casing;
laminating said packaged structure under heat and pressure; and
sealing said polymer-cased package structure.

26. The method of claim 25, wherein the binder material is selected from the group consisting of polyvinylidene fluoride (PVDF), polyurethane, polyethylene oxide, polyacrylonitrile, polymethylacrylate, polyacrylamide, polyvinylacetate, polyvinylpyrrolidone, polytetrafluoroethylene, glycol diacrylate, hexafluoropropylene (HFP), chlorotetrafluoroethylene (CTFE) and copolymers of the foregoing and combinations thereof.

27. The method of claim 26, wherein the binder material comprises polyvinylidene fluoride (PVDF).

28. The method of claim 25, wherein said binder solution comprises about 2% (by weight) PVDF in about 80 to 90% acetone-20 to 10% ethanol.

29. The method of claim 25, wherein said binder solution comprises about 2% (by weight) PVDF in about 90% acetone-10% ethanol.

30. The method of claim 25, wherein said binder solution comprises about 2% (by weight) PVDF in about 88% acetone-2% NMP-10% ethanol.

31. The method of claim 22, wherein said coated separator has a porosity such that the time for a known volume of air to pass through an area of coated separator is no more than three times the time for the known volume of air to pass through the same area of the uncoated porous separator material under the same conditions.

32. An electrochemical cell binder solution, comprising:
a binder material:
at least two solvents, wherein a first of said at least two solvents has higher solubility for the binder material and a lower boiling point than a second of said at least two solvents, and wherein the solution of binder material does not gel at a temperature below 30° C. in less than 4 hours.

33. The binder solution of claim 32, wherein the solution of binder material does not gel at a temperature below 30° C. for a minimum of 8 hours.

34. The binder solution of claim 1, wherein the solution of binder material does not gel at a temperature below 30° C. for a minimum of 12 hours.

35. The binder solution of claim 32, wherein the binder material is selected from the group consisting of polyvinylidene fluoride (PVDF), polyurethane, polyethylene oxide, polyacrylonitrile, polymethylacrylate, polyacrylamide, polyvinylacetate, polyvinylpyrrolidone, polytetrafluoroethylene, glycol diacrylate, hexafluoropropylene (HFP), chlorotetrafluoroethylene (CTFE) and copolymers of the foregoing and combinations thereof.

36. An electrochemical cell electrode separator, comprising:
a porous separator material; and
a porous coating of a binder formed on the separator material;
wherein said coated separator has a porosity such that the time for a known volume of air to pass through an area of coated separator is no more than three times the time for the known volume of air to pass through the same area of the uncoated porous separator material under the same conditions.

37. The separator of claim 36, wherein the binder material is selected from the group consisting of polyvinylidene fluoride (PVDF), polyurethane, polyethylene oxide, polyacrylonitrile, polymethylacrylate, polyacrylamide, polyvinylacetate, polyvinylpyrrolidone, polytetrafluoroethylene, glycol diacrylate, hexafluoropropylene (HFP), chlorotetrafluoroethylene (CTFE) and copolymers of the foregoing and combinations thereof.

38. The separator of claim 37, wherein the binder material comprises polyvinylidene fluoride (PVDF).

39. The separator of claim 37, wherein the binder material consists of polyvinylidene fluoride (PVDF) homopolymer.

40. The separator of claim 36, wherein said coated separator has a porosity such that the time for a known volume of air to pass through an area of coated separator is about two times the time for the known volume of air to pass through the same area of the uncoated porous separator material under the same conditions.

41. The separator of claim 36, wherein said coated separator has a porosity such that the time for a known volume of air to pass through an area of coated separator is no more than one and one half times the time for the known volume of air to pass through the same area of the uncoated porous separator material under the same conditions.

42. An electrochemical cell, comprising:
an electrochemical structure, comprising,
a positive electrode,
a negative electrode, and
a porous binder-coated separator separating the two electrodes, wherein said coated separator has a porosity such that the time for a known volume of air to pass through an area of coated separator is no more than three times the time for the known volume of air to pass through the same area of the uncoated porous separator material under the same conditions;
an electrolyte; and
a polymer casing for said electrochemical structure and electrolyte.

43. The cell of claim 42, wherein said coated separator has a porosity such that the time for a known volume of air to pass through an area of coated separator is about two times the time for the known volume of air to pass through the same area of the uncoated porous separator material under the same conditions.

44. The cell of claim 42, wherein said coated separator has a porosity such that the time for a known volume of air to pass through an area of coated separator is no more than one and one half times the time for the known volume of air to pass through the same area of the uncoated porous separator material under the same conditions.
